(19) United States
(12) Patent Application Publication
(10) Pub. No.: US 2026/0149955 A1
(43) Pub. Date: May 28, 2026

(54) METHODS, APPARATUSES AND SYSTEMS RELATED TO REGISTER AND ACTIVATE A DEVICE EDGE REGISTRY FUNCTION

(71) Applicant: InterDigital Patent Holdings, Inc., Wilmington, DE (US)

(72) Inventors: Debashish Purkayastha, Eagleville, PA (US); Kevin Di Lallo, Laval (CA); Robert Gazda, Spring City, PA (US); Michel Roy, Candiac (CA); Michael Starsinic, Newtown, PA (US)

(21) Appl. No.: 18/958,666

(22) Filed: Nov. 25, 2024

(51) Int. Cl. H04W 4/50; H04W 60/00

(52) U.S. Cl. CPC H04W 4/50; H04W 60/00

(57) ABSTRACT

In an embodiment, a method implemented in a Wireless transmit/receive unit (WTRU) comprises transmitting, to a network, a first message comprising first information indicating capability of device edge registry function (DERF); receiving, from the network, a first response message comprising second information indicating that the capability of the DERF of the WTRU is successfully registered; receiving from the network, a second message comprising third information indicating a request to activate the DERF; enabling the DERF; and transmitting, to the network, a third message comprising fourth information indicating the DERF is enabled.

### FIELD OF THE INVENTION

The present disclosure is generally directed to methods and procedures related to registering and activating a device edge registry function. More particularly the present disclosure relates to methods, apparatuses and systems for a device edge registry function to enable discovery of local application server(s), and also to restrict discovery to local application server(s) within a sub network.

### BACKGROUND

Application servers (ASs) in a device edge may be available in multiple tiers of subnetworks, either connected to a private or public network. In each tier of a subnetwork, one or more ASs can process data locally. These ASs could provide and consume services locally among all the ASs available in a subnetwork tier.

Since an AS may consume and provide service locally within a subnetwork tier, it could be important that AS within a subnetwork can discover other ASs within the same subnetwork.

A 3GPP 5G Edge Application Enablement (EDGEAPP) architecture may support a registry function in an edge enabler server (EES), deployed in an edge data network (EDN). An EES supporting a registry function for a device edge may not be optimal, because of fast and frequent information updates from ASs and frequent retrieval of information by AS in a Device Edge compared to the Telco Edge.

There is a need to improve the above issue.

### SUMMARY

In an embodiment, a method, implemented in a wireless transmit/receive unit (WTRU) may comprise a step of transmitting, to a network, a first message comprising first information indicating capability of device edge registry function (DERF). The method may further comprise a step of receiving, from the network, a first response message comprising second information indicating that the capability of the DERF of the WTRU is successfully registered. The method may further comprise a step of receiving from the network, a second message comprising third information indicating a request to activate the DERF. The method may further comprise a step of enabling (e.g., activating) the DERF; and a step of transmitting, to the network, a third message comprising fourth information indicating the DERF is enabled (e.g., activated).

The first information may further indicate any of (i) an identifier of the WTRU, (ii) credentials, (iii) capability indication flag, (iv) DERF details, location information of the WTRU, network information, and service provider information. The DERF details may include any of DERF's IP address, and DERF's port number. The WTRU DERF capability registration at network side may comprise storing the WTRU capability information. The second information may further indicate a DERF profile. The third information may further indicate any of (i) the identifier of the WTRU, (ii) a DERF identifier, (iii) DERF policy details, (iv) location restriction, (v) service provider, (vi) service name, and (vii) device edge management system information (DEMS). The DEMS information may indicate any of an IP address, and Port number, which can be used to reach the DERF. The fourth information may further indicate any of (i) the WTRU identifier, (ii) the DERF identifier, (iii) DERF activation result, (iv) DERF details, (v) credentials, (vi) WTRU location information, (vii) a network identifier, and service provider information.

The step of enabling (e.g., activating) the DERF may comprise a step of transmitting, from a device edge configuration function (DECF) of the WTRU, to the DERF of the WTRU, a DERF activation request message; and a step of receiving, by the DECF of the WTRU, an activation response message comprising information indicating a DERF identifier to identify the DERF profile, and a DERF connectivity information.

The WTRU may be provisioned with a device edge configuration function (DECF) by a device edge compute service provider (DECSP) or a Mobile Network Operator (MNO), with the information about a DECS of the network.

In an embodiment, a WTRU, comprising a processor, a transmitter, a receiver and a memory, may be configured to transmit, to a network, a first message comprising first information indicating capability of device edge registry function (DERF). The WTRU may be further configured to receive, from the network, a first response message comprising second information indicating that the capability of the DERF of the WTRU is successfully registered. The WTRU may be further configured to receive, from the network, a second message comprising third information indicating a request to activate the DERF. The WTRU may be further configured to enable (e.g., activate) the DERF, and to transmit, to the network, a third message comprising fourth information indicating the DERF is enabled (e.g., activated).

### BRIEF DESCRIPTION OF THE DRAWINGS

A more detailed understanding may be from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a block diagram illustrating an example of a 6G subnetwork deployment according to an embodiment;

FIG. 3 is a block diagram illustrating an example of a concept of “Far/Device edge’ according to an embodiment;

FIG. 4 is a block diagram illustrating an example of a 5G edge application architecture according to an embodiment;

FIG. 5 is a block diagram illustrating an example of a device edge deployment according to an embodiment;

FIG. 6 is a block diagram illustrating an example of device edge architectural assumptions according to an embodiment;

FIG. 7 is a block diagram illustrating an example of a device edge service enablement framework according to an embodiment;

FIG. 8 is a signalling diagram illustrating an example of device edge registry function (DERF) registration and activation procedure, according to an embodiment;

FIG. 9 is a signalling diagram illustrating an example of a DERF discovery by a device edge application client (DEAC) or by a device edge application server (DEAS), according to an embodiment; and

FIG. 10 is a flow chart diagram illustrating a method to register and activate a device edge registry function according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A sign, symbol, or mark of forward slash ‘/’ is to be interpreted as ‘and/or’ unless particularly mentioned otherwise, where for example, ‘A/B’ may imply ‘A and/or B’.

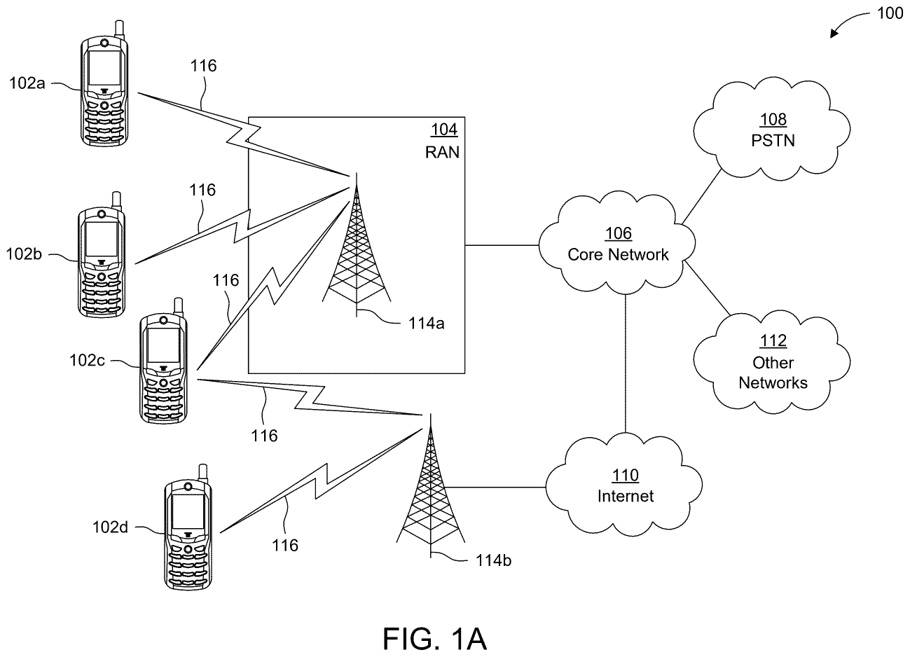

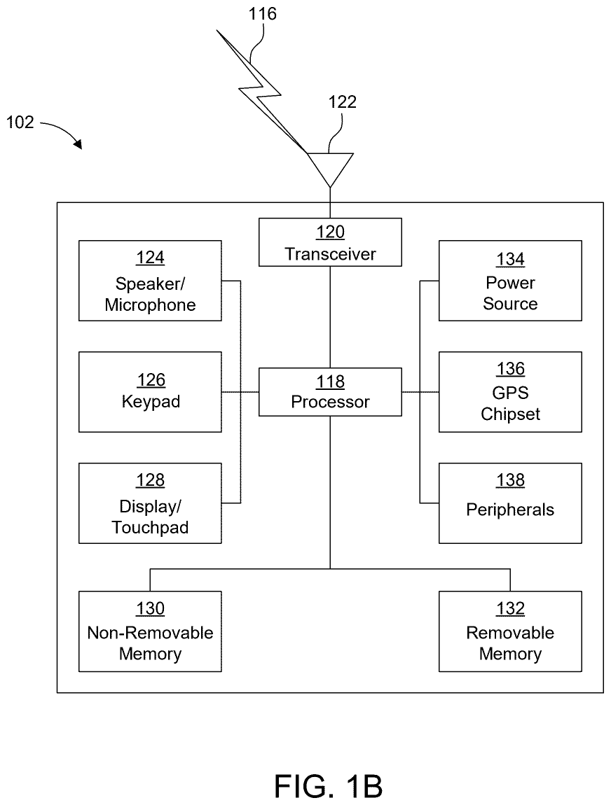

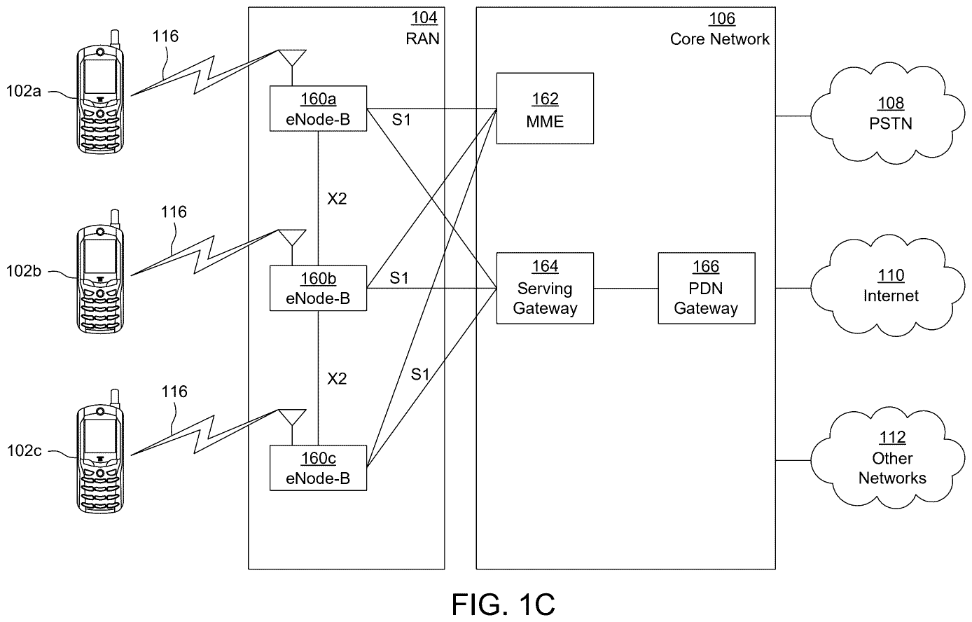

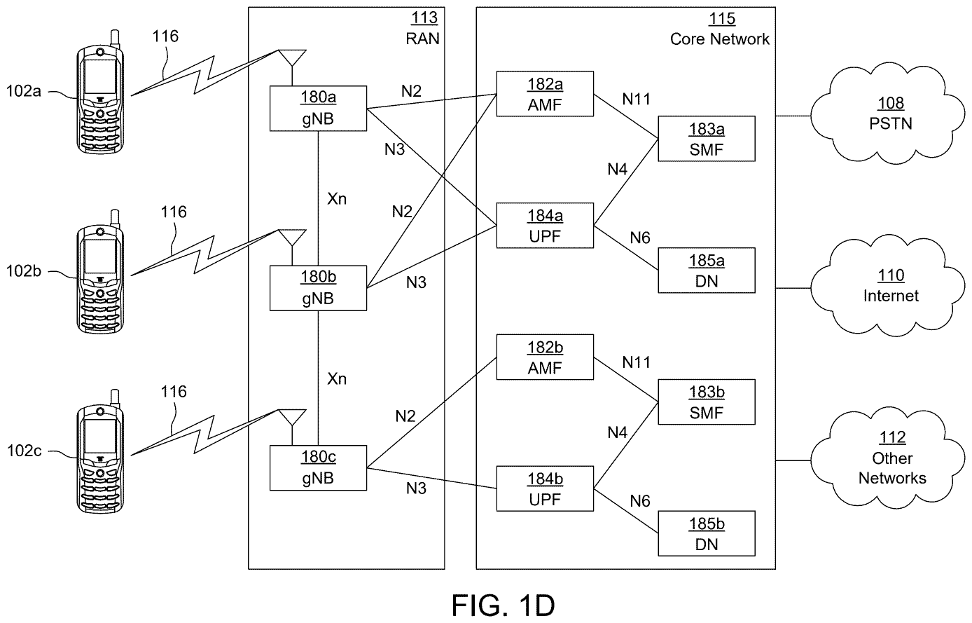

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), an universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

In the above description, the following terminology is used and may be defined as follow.

A device edge may refer to terminal devices (one or more) like a user equipment (UE) or a wireless transmit/receive unit (WTRU), a CPE (Customer Premise Equipment), Gateways, providing cloud services.

A device edge UE may be a UE or a WTRU that can provide edge services. A device edge UE can be realized within different devices like a CPE, vehicle, access point (AP), etc.

A device edge application server (DEAS) may be an application server (AS) running on a device edge UE.

A device edge application client (DEAC) may refer to an application client (AC) which may use the services of a DEAS and runs on device edge UE.

A device edge configuration function (DECF) may be a function in a device edge UE, which can fetch configuration information from service providers configuration servers, to configure other Device Edge functions.

A device edge registry function (DERF) may be a registry function running in a device edge UE. A DERF may maintain a list of services that are available or produced at the device edge.

A device edge configuration server (DECS) may be a server that stores and maintains device edge configuration information. A DECS may be maintained by service providers such as mobile network operator, edge computing service provider, device edge compute service provider.

A device edge management Server (DEMS) may be a server in the mobile network that stores information about DERF, e.g. connectivity information, registered DEAS etc.

A device edge compute service provider (DECSP) may be an edge service provider that supports device edge deployments.

A device edge application vertical (DEAV) may be an application comprised of one or more device edge applications and services (e.g., DEAC and DEAS). For example, a DEAV may be a video surveillance or traffic monitoring application. The Device Edge applications and services that comprise a DEAV may be referred to as DEAV components. For example, DEAV components for video surveillance may include vision capture, vision analysis, threat detection, reporting, and actuation. A DEAV provider may be an application service provider for a vertical application.

A device edge UE location information: a device edge UE location information may include one or many of the following attributes: (i) country code; (ii) civic address combined with a country code; (iii) area, conditionally combined with a county code; (iv) network location information, such as zone information, connected access point information, etc.; (v) additional geographic location information, such as latitude, longitude, altitude, additional shape information (such as area circle), etc.; (vi) indoor location context information, such as floor number, room number, aisle, etc.; (vii) relative distance information, for example between device edge UEs or between device edge UE and terminal devices; (viii); device edge UE identifier(s); and (ix) device edge UE mobility path information

A subnetwork: The term subnetwork may indicate network inside the 3GPP access network. E.g. one or more UE (e.g., WTRU) may connect to a residential gateway RG, which may connect to a gNodeB in a 3GPP network. The UE and RG may form a subnetwork. There can be one or more such subnetworks connecting to the gNodeB. A subnetwork can connect to one or more subnetworks, like a hierarchical network deployment.

Tier: The term Tier may have been used to indicate a level or a layer in the hierarchical deployment of subnetwork. The level can consist of different network nodes, e.g. AP, gateway, router. The level may be not related to any specific function within the subnetwork.

Billions of internet of thing (IoT) sensors, data capture devices, cameras are deployed everywhere, e.g. retail stores, in hospitals, on factory floors. These data capture devices may generate massive amounts of data with the potential to transform business. To handle such massive data, edge computing may provide compute power to where data is collected, reducing bandwidth requirements and time to respond. By reducing the distance between where data is collected and where it's processed, organizations can react quickly to real-time insights, unlocking that potential.

Virtually every industry may invest in edge computing to accelerate artificial intelligence (AI) workloads. Over the next four years, enterprise spending on edge hardware, software, and services will increase at an annual compound growth rate of 12.5 percent, amassing to an estimated $250 billion by 2024, according to IDC's 2020 Edge Spending Guide.

Virtual reality (VR) technology may have been employed in several professional verticals such as education, healthcare, and military over the last few years. Mobile VR is envisioned to be the future owing to its lower price, compact size and portability. However, the processing capability of the mobile VR devices cannot meet the high-fidelity VR requirements. This inevitably leads to unsatisfactory quality of experience (QoE).

The (e.g., extreme) low latency requirement cannot be fully supported by mobile edge computing techniques. This may have lead use of computation techniques in the user device, e.g. foveated rendering, which tracks eyesight in the client device and informs the server. Split rendering architecture may run on client device and servers to reduce computational load in the server and improve quality of experience for the user.

In 2016-2018, Gartner listed digital twin as the top ten strategic technology development trends for three consecutive years and believed that digital twin would produce disruptive innovation. 6G technology and the further maturity of interdisciplinary subjects such as bioscience, materials science, and bioelectronics medicine, may be expected to realize a complete “digital twin of the human body” in the future, that is, through the extensive application of a large number of intelligent sensors (>100 devices/person) in the human body, to accurately carry out important organs, nervous system, respiratory system, urinary system, musculoskeletal, emotional state, etc. In real time health data of the human body may be generated, processed and monitored. More AI techniques may be applied to predict human health, well-being. This may require compute capability to process health data in real time and provide some results, commands. The computation may happen at different levels, such as for every organ data is collected, at a next level the data is aggregated and processed further.

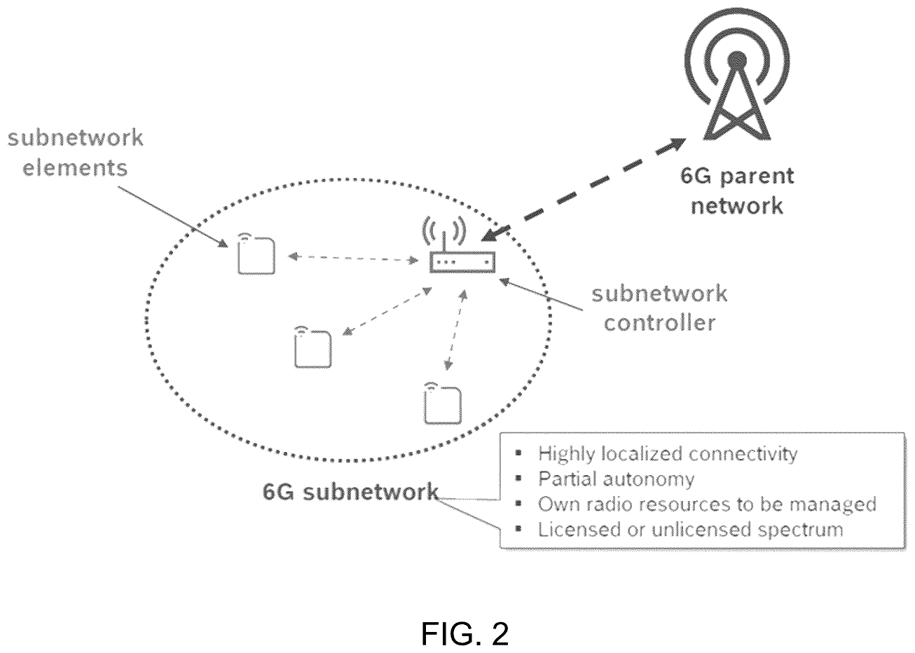

Edge computing deployments in 6G may be in the form of multi-tier hierarchical networks, where several subnetworks terminate in public network. Referring to FIG. 2, an example of a 6G subnetwork deployment is shown. The “6G subnetwork” shown at FIG. 2 may be replicated, so N number of “6G subnetworks” can connect to the “6G parent network”. One or more “6G subnetworks”, connected to “6G parent network”, may be part of a tier. It may be possible that each “6G subnetwork” branches out to one or more “6G subnetworks”, forming a hierarchical deployment with multiple tiers.

Subnetwork deployment may face several challenges to support multi-tier edge clouds such as, dynamic shifting of compute loads (e.g., across multi-tier edge clouds), dynamic application splitting (e.g., to adapt to changing QoS and compute capabilities), partial autonomy of the edge computing system (e.g., in case of loss of connection to parent network), which may include fixed and mobile edge nodes (e.g., fixed access points, mobile device edge UEs).

Data may be processed locally at each tier and may initiate local actions. Data may also be exchanged (e.g., intermittently) between tiers (e.g., between peer subnetwork tiers or between subnetworks and public networks). Examples of subnetworks may include a set of devices forming a network of compute entities and connecting to a public network through a gateway. For example, in the 3GPP Personal IoT Network (PIN) architecture, PIN elements (PINEs) (e.g., PIN client devices) form a subnetwork and connect to a 3GPP network through a gateway (e.g., PIN Element with gateway capability (PEGC)).

Edge node mobility may cause a subnetwork to change its network attachment point. For example, a subnetwork may change attachment point from a private to a public network (e.g., Wi-Fi to 5GS), or a PIN client may change connectivity from a PEGC to the 5GS. An edge node may also change connectivity within a network (e.g., private or public network or subnetwork) by switching from one AP/CPE attachment point to another.

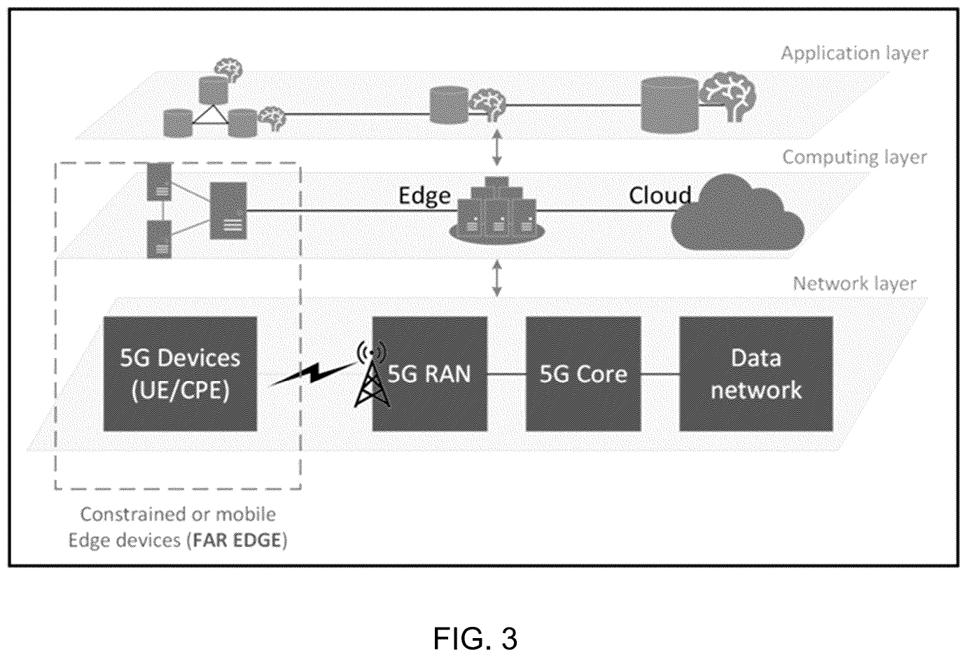

FIG. 3 illustrates a concept of “Far/Device edge”. FIG. 3 shows three logical layers, namely the network layer, computing layer, and application layer and the terminal devices, referred to as device edge

The network layer may be depicted using an end-to-end 3GPP network. The computing layer may be composed of different computing tiers, namely, the central cloud, the edge cloud (e.g. Telco Edge) connected to network edge and terminals, devices, UE, WTRU capable of providing cloud services.

“Far/Device Edge” capabilities may be embedded in the constrained terminal devices or dynamically provisioned. Constrained devices may be battery-powered, mobile, volatile, with limited compute and connectivity as compared to the traditional edge clouds. The constrained devices may collaborate and exchange information among themselves. The application layer, which may provide functionalities such as telemetry, training and inference, may be envisioned to be distributed across different computing tiers, including far edge constrained devices. Applications and functions may be hosted anywhere in the computing stratum (cloud, edge or far edge devices).

Examples of devices, terminals, WTRUs and UEs, which may be considered as part of device edge, are described below.

Small cells deployed inside a building, mall, or enterprise, enhanced with edge capability.

Vehicles enabled with computing capability, capable to provide far edge cloud service to users inside the vehicle, as well as to vehicular applications for autonomous driving and safety. Wireless access, such as 5G, may be used as a backhaul for the in-vehicle constrained device. Roadside units may also be considered in this group.

Sensor-carrying devices, which may be fixed or mobile, such as a robot, camera, a wearable device or an automated guided vehicle (AGV) etc., may be enhanced with edge compute capability. These sensors (possibly also collocated with actuators) may use fixed access or wireless access (e.g., 5G, WiFi) to connect to the network.

Drones/UAVs equipped with computing capability may provide far edge service. These devices may use wireless access such as 5G to connect to the network.

UE (e.g. smart phone) or WTRU, supporting a personal IoT/online gaming/V2X network.

Edge/cloud services on UEs/WTRUs/CPE/Gateways/Vehicle will be referred herein to as device edge.

In 3GPP release 17, work to support native support of edge computing in 3GPP networks was started. These efforts may include initiatives across several working groups in 3GPP including SA6, SA2, SA3, SA4 and SA5, which cover application layer architecture, core network enhancement, security, media processing, and management aspects respectively.

SA6 initiated normative specification work on the architecture for enabling edge applications. The objective of the work may be to define an enabling layer to facilitate communication between the Application Clients (AC) running on the UE and the edge application servers (EAS) deployed on the edge data network. This may include aspects of service provisioning and EAS discovery. In addition, the work aims to provide support services such as application context transfer between EASs for service continuity, service enablement and capability exposure APIs towards the EAS.

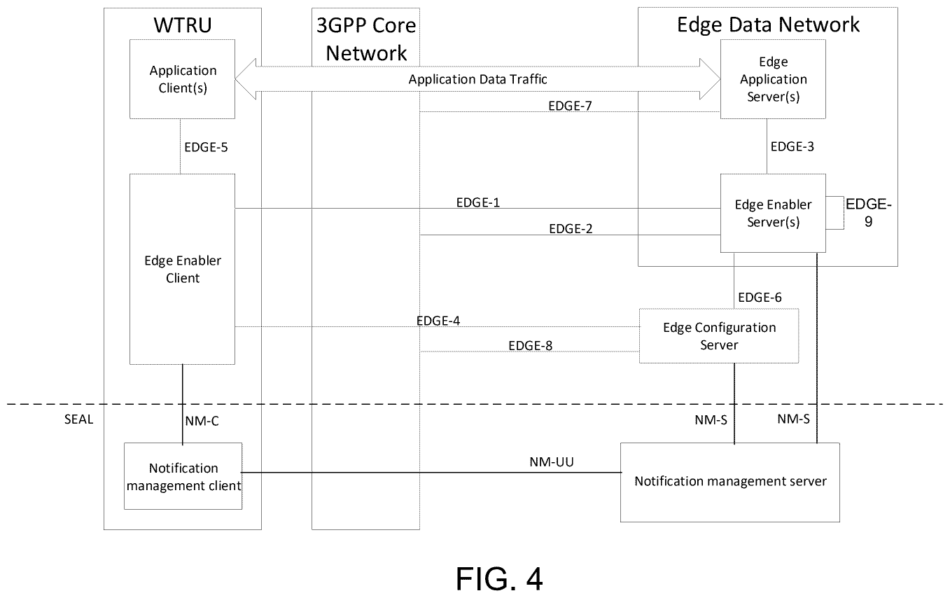

Referring to FIG. 4, the application architecture may comprise of edge enabler server (EES), primarily responsible for enabling discovery of EASs; edge enabler client (EEC), providing support functions, such as EAS discovery to the ACs in the UE; and, edge configuration server (ECS), providing configurations to the EEC to connect with an EAS.

ACs on a UE may be “edge-aware” and “edge-unaware”. With edge-aware applications, the ACs may get the full benefit of the SA6 architecture by directly interacting with and thus leveraging all the benefits of the EEC. For edge-unaware applications, the SA6 architecture may provide significant benefits on behalf of the ACs without their direct participation.

SA2 worked on solutions for edge application support (e.g. using DNS for IP routing to an EAS) that can be deployed independently or in conjunction with the SA6 architecture.

In 3GPP Rel 18, support for access to edge hosting environment in roaming situations and exposure of data/network status via the local UPF/NEF, along with security considerations are considered. For enhancing the edge enabler layer, study item “FS_EDGEAPP” considered improvements such as the support for roaming in the enablers, federation of edge services across different edge compute service providers (ECSPs), service continuity across different network operators and ECSPs, and ACR between EAS and cloud application servers. Enhancement of the management aspect of edge computing was also part of 3GPP Rel 18, it included alignment with GSMA OPG and ETSI MEC specifications.

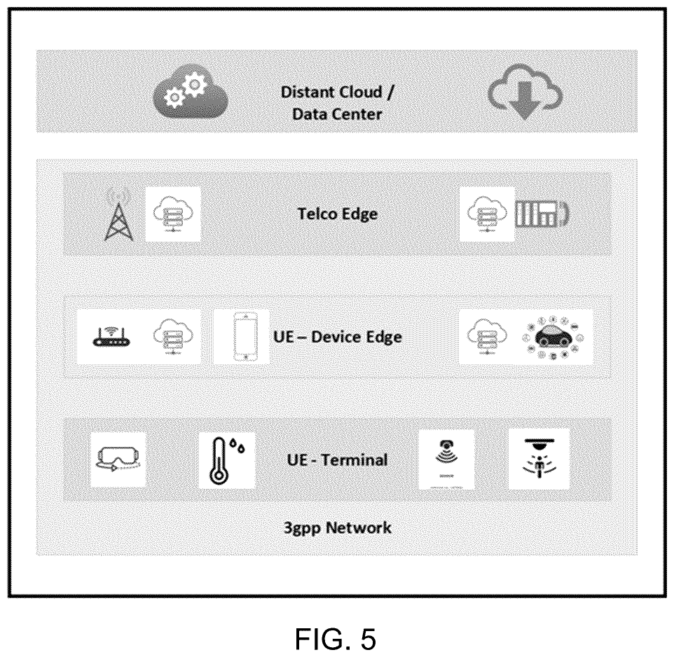

Referring to FIG. 5, it is assumed that “device edge” will be enabled in UE/Devices/WTRU with certain amount of compute resources, e.g. APs, routers, UEs, etc. Referring to FIG. 5, two type of UEs (e.g., WTRUs) are shown:
(i) UE-Device Edge: devices with compute and storage capability that are made available or exposed to device Edge (e.g., in a 6G system) like Smartphones, CPE, Autonomous vehicles, Drones, Mobile Robots, or other devices. Interact vertically (higher tier) or horizontally (peer subnet tier) with other UE—device edge and with Telco Edge. A device edge application may behave as an Application Server (AS) or Application Client (AC) at the same time. Provide compute services to the lower layer UE-Terminals
(ii) UE-Terminal: devices with extremely limited compute and storage capability, like Sensors, Wearables and do not make compute available for device edge. Uses compute capability in UE-device edge, e.g., sensing application in terminal uploads sensed data to UE-device edge for processing.

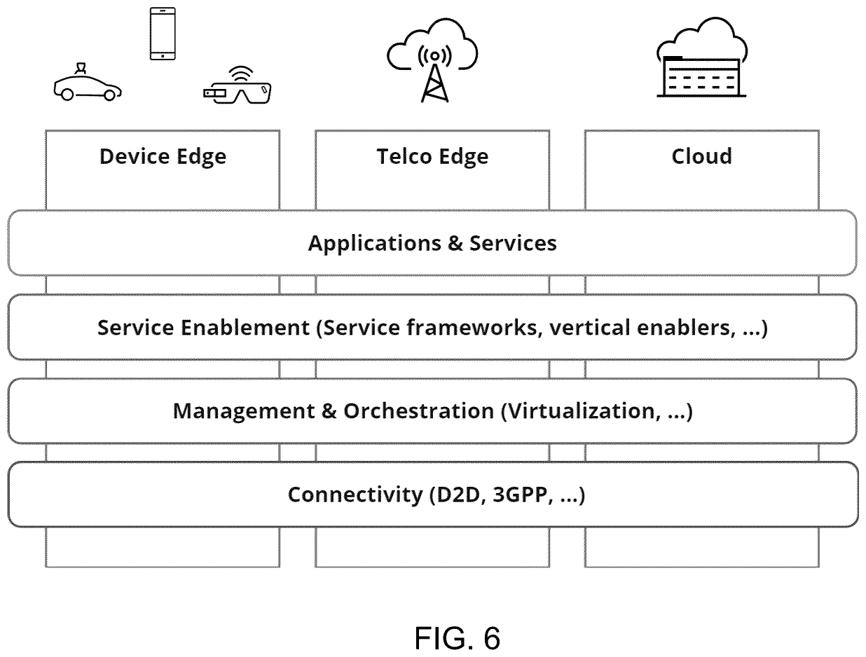

Referring to FIG. 6, a functional architecture/assumption for a device edge is shown. Device edge is viewed as an extension to Telco Edge and cloud, enabling edge services on mobile, resource-limited and resource-sharing devices. Referring to FIG. 6, the functional layers, as in the cloud/edge system, may extend from cloud to Telco Edge to device edge.

Each functional layer is described a follow:
(i) Applications & services layer: may deploy, discover and transfer applications and services between device, network edge and cloud; (ii) Service enablement layer: may provide access to compute resources across networks and domains using service frameworks and vertical-specific application enablers; (iii) Management & Orchestration Layer: may support deployment and configuration of virtual functions and networks on a diverse set of devices and hardware with distinct resources and capabilities; (iv) Connectivity layer: may establish and manage device and network connections to enable communication across devices and data networks.

Application Servers (AS) in a device edge will be available in multiple tiers of subnetworks, either connected to a private or public network. In each tier of a subnetwork, one or more ASs may process data locally. These ASs may provide and consume services locally among all the ASs available in a subnetwork tier.

Since an AS may consume and provide service locally within a subnetwork tier, it may be important that AS within a subnetwork can discover other ASs within the same subnetwork. A local registry of device edge AS may be required to support AS discovery at the subnetwork level. To achieve this, a “device edge registry function” (DERF) for each subnetwork tier may be used. The DERF for each subnetwork may not only enable discovery of local AS(s), but may also restrict discovery to local AS(s) within a sub network.

A DERF in a subnetwork may be updated quickly and frequently by ASs in a subnetwork, about their location, connectivity, availability, etc. The DERF may provide accurate information about local AS(s) to another AS, which is trying to discover a local AS. For example, the DERF may provide information from AS(s) that are relevant (e.g., of interest) to the requesting AS and that are available to produce (e.g., offer) a requested service.

The 3GPP 5G EDGEAPP architecture may support a registry function in an EES, deployed in an EDN. An EES supporting a registry function for device edge may not be optimal, because of fast and frequent information updates from ASs and frequent retrieval of information by AS in the device edge compared to the Telco Edge.

A DERF, deployed locally on a UE (e.g., WTRU) in a device edge, may have the following advantages: (i) scalability, by distributing AS discovery processing and storage to subnetworks. In contrast, a registry function deployed at the network level (e.g., external to a subnetwork) may have difficulty supporting discovery for all AS from all subnetworks; (ii) allows direct connectivity with AC/AS for registration and discovery, in the device edge; (iii) allows fast, dynamic and reliable update of registration and discovery by an AC/AS in device edge; (iv) allows independence of device edge operation from operator and service providers in case of lost connectivity or disaster; (v) may be deployed dynamically in an on-demand basis in the device edge; (vi) privacy/limited exposure of device edge service, information stays in a local context.

However, deploying DERF in device edge has challenges. DERF may be deployed in UE (e.g., WTRU), which may be mobile and with limited compute capability. A change in UE location may impact availability of the DERF. There may be a need to track the location and availability of a DERF and to initiate actions such as re-assignment, re-selection, re-deployment of DERF.

To deploy and operate a DERF in a Device Edge, the following problems need to be addressed: (i) how can a network operator/ECSP/DECSP manage and control the deployment of a DERF in a Device Edge?(ii) how can a network operator/edge service provider maintain configuration information (e.g. IP address/URL) of a DERF and support discovery of a DERF deployed in a Device Edge?(iii) How to enable AS registration and discovery with a DERF, where the DERF is deployed in a mobile UE (e.g., mobile WTRU), within a subnetwork or outside a subnetwork?

In the below various embodiments, “device edge registry function (DERF)” is assumed to be a service enablement layer function, deployed in a Device Edge UE or CPE.

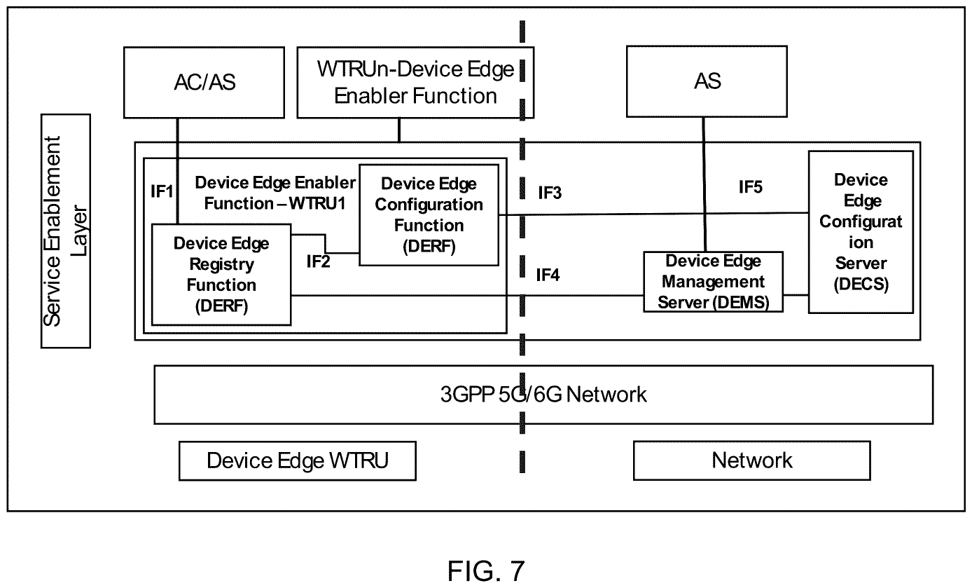

Referring to FIG. 7, a device edge service enablement framework is shown. To enable a DERF in a device edge UE, the device edge service enablement framework may support the functions listed below. It should be appreciated that these functions may be deployed as new services or as enhancements to existing services (e.g., EDGEAPP entities like EEC, EES, and ECS).

A device edge configuration function (DECF), in the UE (e.g., WTRU), may manage configuration information for DERF and configuration information to communicate with other enabler functions. A device edge configuration server (DECS), in the network, may maintain configuration information of all DERF instances deployed in a subnetwork or network. A device edge management server (DEMS), in the network, may interact with DERF to provision, configure, and update information in a DERF.

An ECSP, an application service provider (ASP), a DEAV provider may deploy DERF in device edge UE. A mobile network operator may also trigger the deployment of a DERF in a UE (e.g., WTRU) if configured or requested by ECSP, DECSP, ASP. Not every UE in a device edge will deploy a DERF.

To enable DEAC/DEAS to discover services or register services, the following steps may be executed after deployment of DERF: (i) DERF availability is registered with DECS; (ii) DECS activates DERF, based on requirements from ECSP, ASP or DEAV provider; (iii) DECF discovers appropriate DERF, which will be used by DEAC and DEAS, based on various filtering criterion, e.g. location, network domain etc. The device edge service enablement framework may be used to describe the steps described above.

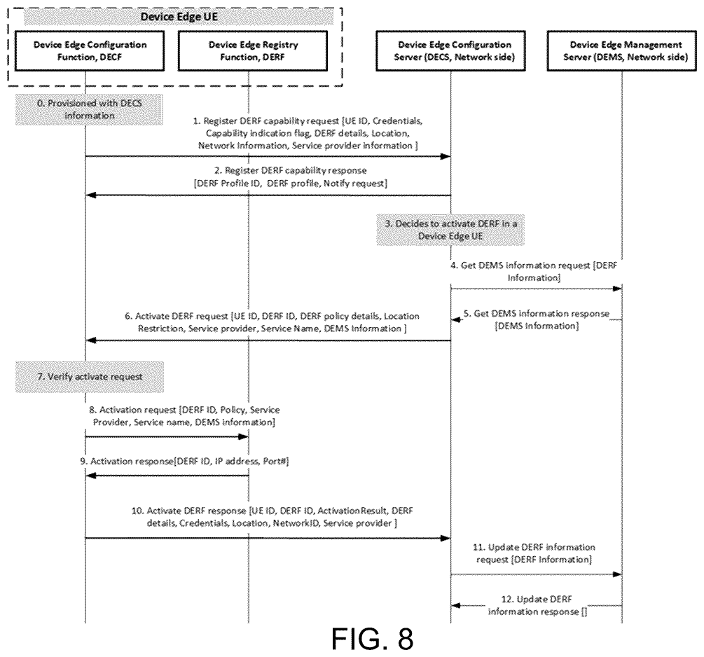

Referring to FIG. 8, in an embodiment, steps involved in activating a DERF and configuring updates in a DERF are shown.

At step 0, a DECF is available in a UE (e.g., WTRU). The DECF may be provisioned by a device edge compute service provider (DECSP) or a mobile network operator (MNO), with information about a DECS. DECS information may include any of a DECS connectivity information (e.g., IP address, port number, URL), a credentials to authenticate the UE with the DECS, information about the DECSP (e.g., DECSP name), and DEAV information (e.g., identifier, name, type).

At step 1, when the UE joins a network (during startup, roaming), the DECF may indicate to the DECS about the UE's DERF capability by sending a “register DERF capability request” message.

The request message may comprise information that indicates to the DECS that the UE can perform DERF functions. The indication may include any of the following. (i) The UE identifier (UE ID), for the DECS to identify the UE with DERF capabilities. (ii) Credentials, for the DECS to authenticate the request. (iii) An indication about whether the UE can perform DERF functions; for example, a “DERF capable” flag indicating whether the UE has a DERF deployed and running (the DERF's state can be active or inactive). (iv) DERF details, to provide information about the DERF. As a first example, DERF identifier (DERF ID) to identify the DERF for authentication and authorization by DECS. DERF ID may be used to identify DERF profile, which is maintained in DECS. As a second example DERF capabilities. DERF capabilities may include the maximum number of ASs that may be registered at one time, connectivity information to reach the DERF (e.g., IP address, port number, etc.). The capability information may be used to select a DERF by DECS for activating the DERF for a DEAV. (v) A DERF status, to indicate whether the DERF is active or inactive. Active state may mean that the DERF is deployed and providing services for a DEAV. Inactive state may mean that DERF is deployed but not providing service to a DEAV. DECS may use this information to select and configure DERF. (vi) Location information of the UE, like network attachment point, geographic location information, street address, landmarks, buildings and floors, etc. This is same as device edge UE location. DECS may use this information to select a DERF, which matches location requirement for a DEAV or ECSP. (vii) Network ID/Name/Network operator, to indicate which network the UE is connected to (e.g., 3GPP, WiF, etc). The network information may be used by DECS to select a DERF, which can be reached by other Device Edge UE. It may can include one or more information like Network type: WiFi, 3GPP etc, and/or NetworkID: SSID, PLMNID etc. (viii) ECSP/DECSP information, to indicate to the DECS about the owner of the DERF, such as an ECSP, DECSP, MNO or any other third-party service provider. This information may be used by DECS to select a DERF owned by the same ECSP, DECSP. DECS may select a DERF, which may be allowed to be used by an ECSP, DECSP, based on the ECSP/DECSP information. It may include one or more information like, service provider name, e.g. ECSP_A, DECSP_B, MNO_C, business_ID, affiliation, and/or credentials

At step 2, the DECS, after receiving the request message, may authenticate a device using the UE ID and received credentials. If authenticated, the DECS may create or update a DERF profile associated with the requestor UE with all the information received in the request.

The DERF profile may include a DERF profile ID (e.g., a unique identifier of the DERF profile), policy information for DERF operation (e.g. location restriction, time restriction, supported DEAV, etc.), DEMS information (e.g., DEMS connectivity information). In this step 2, DECS may store information, which may be received in the request message, in the DERF profile.

The DECS may be configured with or may obtain policy information from an AF deployed by an ECSP, DECSP, or MNO. DECS may store policy information in the DERF profile, if available. The policy information may be updated later by the AF at the time of activation.

The DECS may obtain the DERF-specific DEMS information by requesting this information from the DEMS and may store in the DERF profile. DECS may also get the DEMS information at the time of activation and may update DERF profile at that time.

The table below is an example of a DERF profile

| Attribute | Cardinality | Type | Description |
|---|---|---|---|
| Profile ID/DERF ID | 0 . . . 1 | String | Identifies the DERF |
| | | | profile |
| UE ID | 0 . . . 1 | String | Identifies the UE with |
| | | | DERF capability and |
| | | | where the DERF is |
| | | | running |
| Security credentials | 0 . . . 1 | String | Security credentials, |
| | | | required security |
| | | | mechanism to access |
| | | | the DERF |
| DERF Capability | 0 . . . 1 | Structure | |
| >maxAS | 0 . . . 1 | Int | Maximum number AS |
| | | | can register |
| >connectivity | 0 . . . 1 | Structure | Connection capability |
| capability | | | for the DERF, like |
| | | | 3GPP, WiFi, D2D, IP |
| | | | address, Port#, URL |
| | | | etc. |
| DERF Status | 0 . . . 1 | Boolean | 0 == Deployed/ |
| | | | running but Inactive |
| | | | 1 == Deployed/ |
| | | | running but Active |
| Location Information | 0 . . . 1 | Structure | Location of the device |
| | | | edge UE, e.g. Geo |
| | | | location information, |
| | | | Postal information, |
| | | | Civic address etc. It |
| | | | can also include |
| | | | “mobility path |
| | | | information”. This can |
| | | | be same as “Device |
| | | | Edge UE Location” |
| | | | described earlier. |
| NetworkInformation | 0 . . . 1 | Structure | Details about the |
| | | | network, the Device |
| | | | edge UE is connected |
| | | | to. |
| ServiceProvider | 0 . . . 1 | Structure | Name of ECSP, |
| | | | DECSP, MNO, etc. It |
| | | | can include, Name, |
| | | | ID, Credentials etc. |
| PolicyInformation | 0 . . . 1 | Structure | Policy related to |
| | | | DERF operation, e.g. |
| | | | Location restriction, |
| | | | Time restriction, |
| | | | Supported DEAV, etc. |
| DEMS Information | 0 . . . 1 | Structure | DEMS connectivity |
| | | | information, e.g. IP |
| | | | address, Port#, URL |

The DERF profile may be maintained by the DECS. The DECS may update the DERF profile as information changes. The DECS may also share the DERF profile with DECF. The DECF may update the DERF profile in the DECS if profile information changes at the DECF. (Note: The synchronization of the DERF profile between DECF and DECS is not shown in detail)

The DECS may transmit a “register DERF capability response” message to the DECF, indicating that the register DERF capability request received in step 1 was successfully processed. The “register DERF capability response” message may further comprise information indicating that the DERF profile has been created or updated. The response may include the DERF profile. The response may further include a DERF profile identifier (e.g., ID, URI). The response may also include an indication for the DECF to provide updates to the DECS if any changes happen to the DERF details (e.g., status, location, connectivity, etc.).

At step 3, DECS may decide to activate DERF, based on policy information provisioned in the DECS, after receiving the “register DERF capability request” message. On the other hand, MNO, ECSP, DECSP or DEAV provider may trigger the DECS to activate a DERF in a specified location or network (e.g., subnetwork). DECS may receive the trigger to activate DERF when ECSP, DECSP, DEAV provider or MNO wants to at least: (i) deploy device edge service for the first time, (ii) extend existing deployment of device edge service, (iii) change device edge service, which was previously deployed in a specific location, due to reasons such as reliability, security etc., and/or address unavailability of device edge service in a location and re-deploy DERF.

DECS may also get policy information related to DERF function with the trigger.

The DECS may search through the stored DERF profiles to obtain a list of UEs (e.g., WTRUs) with DERF capabilities in a specified location or network. The search can result in the following three scenarios.

At scenario 1, DERF is available, and the DERF status is set to “Inactive”. The DECS may decide to activate the DERF. The DECS may create a DERF profile with available information.

At scenario 2, DERF is available, and the DERF status is set to “Active”. The DECS may decide to configure DERF to support a DEAV requested by an ECSP or DECSP. The configuration information may include a DEAV name (e.g., “Traffic Safety”), a DEAV provider name, and security credentials. The DECS may update/create a DERF profile with available information

At scenario 3,

DERF not found, (e.g., if no DERF capability was registered or if the Device Edge UE indicated its presence but cannot perform DERF capability). The DECS may indicate the MNO, ECSP or DECSP about DERF or device edge UE unavailability. This may be an error condition.

At step 4, the DECS may request DEMS for details, e.g., authorized owner of DEMS, authorized user/function allowed to use DEMS, supported DEAV provider etc. and connectivity information, which are used for DERF configuration. The DECS may transmit a request message comprising information indicating a request for configuration information by sending a “Get DEMS information request” message to the DEMS. The DEMS may be selected by the DECS based on DERF profile information (e.g., ECSP/DECSP that owns and operates the DERF). The request may include all information from the DERF profile. For example, the request may include any of: (i) A DERF ID, which may identify a DERF profile, (ii) DERF connectivity information, e.g., IP address, Port #, URL, used by DEMS to contact DERF, (iii) location information of the DERF like geo location, street address, civic address etc. This may be same as “device edge UE location” described earlier, and (iv) service provider information, indicating which ECSP or DECSP owns and allowed to provide DERF function.

At step 5, the DEMS may receive the Get DEMS information request from the DECS. The DEMS may store the information included in the request. The DEMS may use this information to discover and interact with DERF.

The DEMS may act as a network level registry function. External queries for available DEAV components in the device edge, originating outside the network domain, may be first handled by the DEMS. The DEMS may then select an appropriate DERF which can resolve the query based on UE ID, location, network ID, service provider like ECSP, DECSP information.

For DEAV components queries originating from inside the network domain, the DERF may forward the query to the DEMS for queries which cannot be resolved locally by the DERF. The DERF may also update the DEMS about available DEAV components in the DERF network domain.

The DERF may need to be configured with any of the following DEMS information: (i) connectivity details of the DEMS like IP address, Port #, URL etc., and (ii) allowed service providers like ECSP or DECSP, MNO. For example, the DERF may contact the DEMS to query for DEAV components, provided by the same DEAV provider but could not be discovered, to support a DEAV (e.g., a traffic monitoring application vertical).

The DEMS may respond to the DECS by sending a “Get DEMS information response” message. Said response message may include the DEMS information. The DEMS information may include any of: (i) connectivity details of the DEMS like IP address, Port #, URL etc., which can be used by the DERF to interact with the DEMS; (ii) allowed service providers (e.g. ECSP, DECSP), that may indicate DERF can contact for services provided by the “Allowed service provider”; and (iii) allowed DEAV, that may indicate which DEAV(s) are supported by the DEMS and for which the DERF may contact the DEMS about.

At step 6, the DECS may update the DERF profile with DEMS information. The DECS may indicate the DECF to activate the DERF by transmitting an “Activate DERF” request message. Said request message may include the DERF profile. The DERF profile information elements, that are described here to clarify the purpose/use of the information, may comprise any of: (i) UE ID to identify the UE where the DERF will be activated; (ii) DERF ID to identify the DERF profile; (iii) DERF policy information such as how many services can be supported, who may be allowed to use the DERF (e.g., allowed providers (ECSP/DECSP) or users. The DERF policy information may also include location restrictions (e.g., to indicate locations or areas within which applications may register with and discover the DERF). Location restrictions may also indicate the area within which a mobile DERF can operate. (iv) Service provider, such as ECSP or DECSP name, who are allowed to use the DERF; (v) DEAV name that may indicate the application verticals which are supported (e.g., security monitoring, weather sensing); and (vi) DEMS information that may indicate how to connect to the DEMS (e.g., IP address, Port number, URL etc.), allowed DEAV that may indicate which DEAV are supported, allowed service providers (e.g. allowed ECSP, DECSP etc.) that may indicate DERF can contact for services provided by the “Allowed service provider”.

At step 7, the DECF may authenticate the “Activate DERF” request message received from the DECS. If authenticated, the DECF may check if all required DERF configuration information are available, correct. DERF may be configured with the information. If all configuration information is available and correct, DECF may create or update and store the DERF profile.

At step 8, the DECF may activate and configure the DERF by sending an activation request message to the DERF. Said request message may include all the information in the DERF profile received in the activate DERF request from the DECS.

For example, any of the following DERF profile information elements may be used to active and configure a DERF. (i) DERF ID that may Indicate the DERF profile ID, which identifies the DERF profile information. The DERF profile may include DERF details (e.g., capability, policy, etc.). The DERF profile may be maintained by the DECF and the DECS. The DECS may be the owner of the DERF profile, may share the DERF profile with the DECF, and may be responsible for synchronizing the DERF profile with the DECF. (ii) DERF policy that may include information about supported DEAVs, and restrictions on using the DERF (e.g., location, time, etc.). (iii) Service provider (e.g., ECSP, DECSP): Service provider details like name, credential, who can use the DERF. (iv) DEAV name that may indicate the name of the DEAVs (e.g. security monitoring, production line monitoring) which are supported by the DERF. (v) DEMS information that may indicate the DEMS with which the DERF can interact to resolve service-related queries, and to provide updates about available services, etc. The DEMS information includes a DEMS IP address, port number, URL, supported DEAV and supported service providers.

At step 9, the DERF may be activated and may respond to the DECF with an activation response message. The activation message may comprise information indicating any of (i) a DERF ID to identify the DERF profile. The DECF may update the profile with the DERF state after activation. (ii) A DERF connectivity information (e.g., IP address, port number, URL) of the DERF. The DECF may update the DERF profile with the DERF connectivity information.

At step 10, the DECF may transmit an “Activate DERF response” message to the DECS to indicate the DERF was successfully configured and activated and may include any information from the activation response message received from the DERF in step 9.

The Activate DERF response message may include an updated DERF profile. DECS may store the updated DERF profile. The updated DERF profile may include any of the information described in detail below.
(i) UE ID, indicating the device edge UE, where the DERF is active and running.
(ii) DERF ID that may indicate the DERF profile ID, which may identify DERF profile information. The DERF profile may include information about the DERF, like its capability, supported services, allowed service providers, credentials, any restrictions related to location, services, time-based restrictions, etc. The DERF profile may be maintained at the DECF and at the DECS.
(iii) DERF details that may indicate DERF connectivity options (e.g., IP address, port number, URL).
(iv) DERF status that may be set to “ACTIVE” to indicate that the DERF has been activated
(v) DERF location that may indicate where the DERF is deployed and active (e.g., geographic location, civic address, street address, etc.). This can be same as “device edge UE location” described earlier.
(vi) Network ID that may indicate which network the device edge UE is connected to. E.g. this may indicate a public land mobile network (PLMN) ID, service set identifier (SSID), non-public network (NPN) ID, subnetwork ID etc.
(vii) Service provider (e.g., ECSP, DECSP): Service provider details like name, an indication of who can use the DERF, and
(viii) DEAV name that may indicate the name of the vertical applications (e.g. security monitoring, production line monitoring) supported by the DERF.

At step 11, the DECS may update the DEMS with DERF information by transmitting an “Update DERF information” request message. Said request message may include all information from the updated DERF profile in the “Update DERF information” request received from the DECF. For example, the “Update DERF information” request message may include DERF information, which may include any of the following:
(i) UE ID that may indicates the device edge UE, where the DERF is active and running.
(ii) DERF ID that may indicate the DERF profile ID, which identifies DERF profile information. The DERF profile may include information about DERF, like its capability, supported services, allowed service providers, credentials, any restrictions related to location, services, time-based restrictions, etc. The DERF profile may be stored by DEMS.
(iii) DERF details that may indicate DERF connectivity options (e.g., IP address, port number, URL). This information is used by DEMS to interact with DERF.
(iv) DERF Status that may be set to “ACTIVE” to indicate that the DERF has been activated, and
(v) DERF location that may indicate where the DERF is deployed and active (e.g., geographic location, civic address, street address, etc.). This can be same as “Device Edge UE Location” described earlier.

At step 12, the DEMS may update and store the DERF information, including the connectivity information and the DERF status. The DEMS may transmit an “Update DERF information” response message to the DECS. DEMS can use DERF information to contact DERF when it receives query for DEAV components provided by same DEAV provider.

In an embodiment, a method implemented in a device edge UE to register and activate a device edge registry function may comprise a step wherein the device edge UE (e.g., DECF) may indicate (e.g., 5G) network function (e.g., DECS) that it may be capable and available to activate and run device edge registry function. The DECF may indicate any of the Device ID, DERF details like it's IP address, Port #, Location details, Network it is connected to, Service provider information

The method may comprise a step wherein the device edge UE (e.g., DECF) may receive indication from the (e.g., 5G) network function (e.g., DECS) that the request has been validated and the availability information has been stored. DECS may indicate to be notified, if any information about DERF changes.

The method may comprise a step wherein the device edge UE (e.g., DECF) may receive a request message from the (e.g., 5G) network function (e.g., DECS), to activate DERF, after DECS decides to activate DERF. The request message to activate DERF may comprise information indicating any of the UE ID, DERF policy, location restriction, service provider name who owns and allowed to use the DERF, and supported DEAV name and information about a network function (DEMS), which allows DERF to interact with it, to discover DEAV components.

The method may comprise a step wherein the device edge UE (e.g., DECF), may transmit an activation request message to DERF. The activation request message may include any of a device ID, a DERF ID used to identify DERF profile, a policy applicable for the DERF, a service provider who owns and allowed to use the service, and a DEAV name to be supported by the DERF and DEMS information such as IP address, Port number, URL.

The method may comprise a step wherein the device edge UE (e.g., DECF) may receive a message from DERF indicating that the activation is successful. Said message may comprise information indicating any of DERF details like its IP address, and Port #etc, which can be used to reach the DERF function.

The method may comprise a step wherein the device edge UE (e.g., DECF) may transmit a message to the (e.g., 5G) Network Function (DECS) indicating the successful activation of DERF. The message may include DERF details like its IP address, and/or Port #etc, which can be used to reach the DERF function. The message may also comprise information indicating any of a DERF ID to identify the DERF, a location, a network it is connected to, a service provider who owns the DERF and can use.

A DERF, deployed in a device edge UE, may be used by a device edge application client (DEAC) and a device edge application server (DEAS). A DERF may be deployed on the same UE (e.g., WTRU) as the DEAC and/or DEAS, or may be deployed on a different UE e.g., different WRU) than the DEAC and/or DEAS. A DECF may be (e.g., typically) deployed on the same UE as a DEAC and/or DEAS, however it may be deployed on a different UE than the DEAC and/or DEAS. These different deployment options may not impact the DERF discovery procedure, because these interactions may take place over logical interfaces among various functions.

A DEAC may contact a DERF to discover services produced by DEAS instance. A DEAS may contact a DERF to register produced services for discovery. Irrespective of where DECF, DEAC or DEAS are deployed, a DEAC and a DEAS should be able to discover the DERF that is appropriate to support an application vertical (e.g., DEAV).

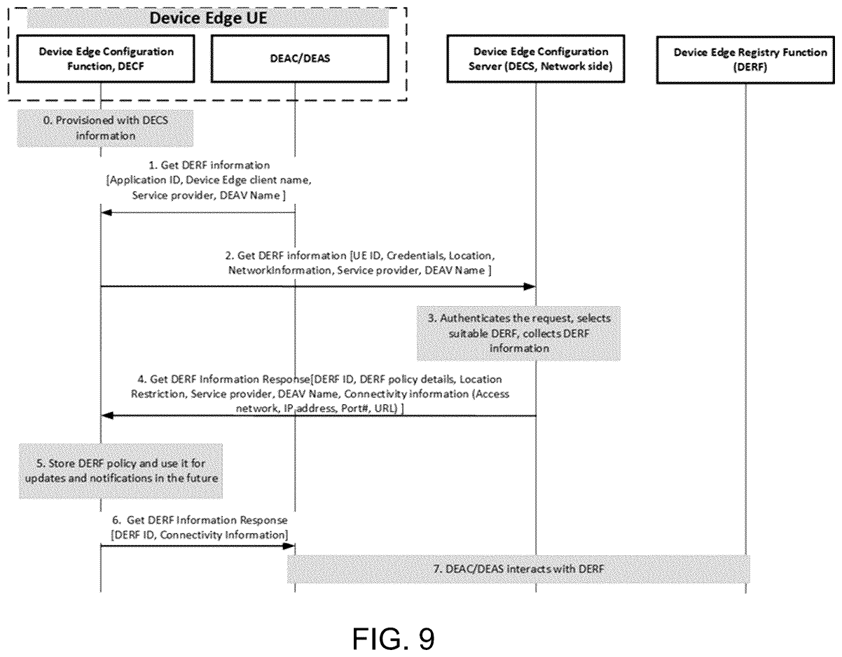

Referring to FIG. 9, an example of a procedure/method for a DEAC and/or DEAS to discover a suitable DERF is shown. The DERF may be assumed suitable when it matches discovery criteria such as location, supported DEAV, capability, owner, connectivity option, etc.

At step 0, a DECF may be available in a UE (e.g., a WTRU). The DECF may be provisioned by a device edge compute service provider (DECSP) or a mobile network operator (MNO), with information about a DECS. DECS information may comprise information indicating any of a DECS connectivity information (e.g., IP address, port number, URL), credentials to authenticate the UE with the DECS, information about the DECSP (e.g., DECSP name), and DEAV information (e.g., identifier, name, type).

At step 1, a DEAC/DEAS may want to interact with a DERF for service discovery or service registration. E.g. a sensing application (DEAS), which captures data and publish the data for consumption by other application clients, may need to register the service with DERF. The registration with DERF will allow application clients to discover the service. To register the service with DERF, DEAS may need to discover DERF. DEAS may discover DERF by transmitting discovery request to DECF.

DEAC/DEAS may trigger DERF discovery procedure with the DECF. The DEAC/DEAS may start DERF discovery by sending a “Get DERF Information” request message to the DECF. The request message may comprise information indicating any of the following.
(i) Requestor information (e.g., DEAS/DEAC identifier, DEAS/DEAC name, DEAS/DEAC type) to provide information about the requestor to the DECF. The DECF may select a DECS to contact based on the requestor information. The DECF may use the requestor information to send the response back to the requestor.
(ii) Credentials to authenticate the Device edge clients (e.g., DEAC, DEAS), which can be owned by third party service providers, DEAV etc.
(iii) DEAV provider that may indicate the owner of the DEAC/DEAS (e.g., DEAV components). The DEAV provider may be an MNO, ECSP, DECSP, or a third party service provider. Depending on the DEAV provider, a specific DECS may be chosen by the DECF.

And (iv) a DEAV name indicating a supported application vertical. The DEAV name may indicate a specific application vertical (e.g., temperature monitoring, vision analysis, etc.) to discover, or it can indicate that the DEAS/DEAC is a component of a specific application vertical (e.g., “Security monitoring by XYZ”, “Autonomous driving by ABC”). The DEAV name may also influence the selection of a DECS, if a DECF is provisioned with more than one DECS. For example, the DECF may select a DECS that supports the requested DEAV.

At step 2, the device edge UE (e.g., the DECF), may transmit a request message to the DECS to obtain DERF information, by sending a “Get DERF Information” request message to the DECS.

Step 2 may also happen independently during UE startup, initialization. It may be triggered due to changes of any of location, network, and access methods. DECF may be notified about the changes and triggers the same procedure. The notification control can be configured in DECF by DECS

The request message may include all information obtained from the “Get DERF information” request received from the DEAC/DEAS. For example, the request message may comprise information indicating any of the following.
(i) a Device/UE ID that may indicate the device edge UE, where the DEAC/DEAS may be active and running. This information may be used by the DECS to identify and authenticate the UE (e.g., WTRU) and to determine a suitable DERF.
(ii) Credentials: DEAC/DEAS credentials received in Step 1. DECS may use this credential to authenticate if the DEAC/DEAS is allowed to access the DERF. DECF credentials, for the DECS to authenticate the request from DECF.
(iii) Location that may indicate the location of the device edge UE. This can be same as “Device Edge UE Location” described earlier. The location information may comprise information indicating a device edge UE location information such as, geographic location, civic address, street address, etc. The DECS may use the location information to select a suitable DERF, which can support the requestor DEAC/DEAS.
(iv) a network information that may indicate the network to which the device edge UE is connected. It may comprise information indicating any of a network ID, a network name, and a network operator. It may also indicate which network the device edge UE is connected to (e.g., 3GPP, Wi-Fi, etc.). This information may be used by the DECS to select a DERF, which can be reached optimally by the DEAC/DEAS.
(v) DEAV provider that may indicate the owner of the DEAC/DEAS. This can be the MNO, ECSP, DECSP, or third party service provider. Depending on the DEAV provider, a specific DERF may be chosen by the DECS.
(vi) A DEAV name that may indicate a supported application vertical. The DEAV name may indicate a specific application vertical (e.g., temperature monitoring, vision analysis, etc.) to discover, or it can indicate that the DEAS/DEAC is a component of a specific application vertical (e.g., “Security monitoring by XYZ”, “Autonomous driving by ABC”). The DEAV name may also influence the selection of a DERF. For example, the DECS may select a DERF that supports the requested DEAV.

And (vii) connectivity information that may indicate a UE connectivity capability. It can indicate an IP address, port number, or URL. This information may be used by the DECS to select a DERF that can be reached optimally by the DEAC/DEAS.

At step 3, the DECS may authenticate the requests based on any of a UE ID, credentials, DEAV provider and DEAV name. If the request is authenticated, the DECS may select a DERF in a device edge UE based on filters such as any of a location information, a network information, DEAV name and a connectivity Information.

The DECS may collect DERF details such as any of a IP address, a port number, an access credentials, a chosen and/or preferred connectivity options, a DERF policy associated with the DERF (e.g., Location restriction for DEAC/DEAS to access the DERF), a supported DEAV providers, an access rules indicating who is allowed to access the DERF, a supported DEAV names, and services supported by the DERF. The preferred connectivity options between the DERF and the DEAC/DEAS may be determined by matching UE connectivity capabilities from step 2 of FIG. 9, and DERF connectivity capabilities in the DERF profile.

At step 4, the DECS may responds to the “Get DERF Information” request received from the DECF in step 2 by transmitting a “Get DERF Information” response message to the DECF. Said response massage may indicate whether the request was successfully processed, and whether a DERF is available to be accessed by the DEAC/DEAS. The response message may include the DERF information collected by the DECS.

The response message may comprise information indicating any of the following:
(i) A DERF ID that may indicate the DERF profile ID, which may identify DERF profile information. The DERF profile may include information about a DERF such as its capability, supported services, allowed service providers, credentials, any restrictions related to location, services, time-based restrictions, etc. The DERF profile may be maintained at the DECF and at the DECS.
(ii) DERF policy details that may indicate any of how many services can register, what priority can be assigned to services, how many queries it can handle, etc.
(iii) Location restriction that may indicate that the DECF/Device Edge UE may use the DERF only in the indicated location, such as geographic location, street address, civic address, etc.
(iv) DERF connectivity information that may indicate connectivity options like IP address, port number, URL
(v) A service provider: Service provider details like name, credential, indicates who can use the DERF and who owns the DERF
(vi) a DEAV name that may indicate the name of the application verticals (e.g., Security monitoring, Production line monitoring) that are supported by the DERF

At step 5, the DECF may store the DERF information received in step 4 of FIG. 9. This information may be used by the DECF to trigger a new request for DERF discovery. For example, the DECF may trigger a new request for DERF discovery when the device edge UE is out of a location restriction area. The DECF may initiate DERF re-discovery based on triggers from other services/functions, such as location services, OS triggers, etc.

At step 6, the DECF may respond to the “Get DERF Information” request received from the DEAC/DEAS in step 1 of FIG. 9 with a “Get DERF Information” response message. The response message may include all information received in the “Get DERF Information” response received from the DECS. The response message may include any of (i) a DERF ID that may indicate the DERF profile ID, which identifies DERF profile information, and (ii) a connectivity information that may indicate connectivity options like IP address, port number, URL for the DERF.

At step 7, DEAC/DEAS may use the DERF information e.g. connectivity information, received in step 6 of FIG. 9, to interact with DERF.

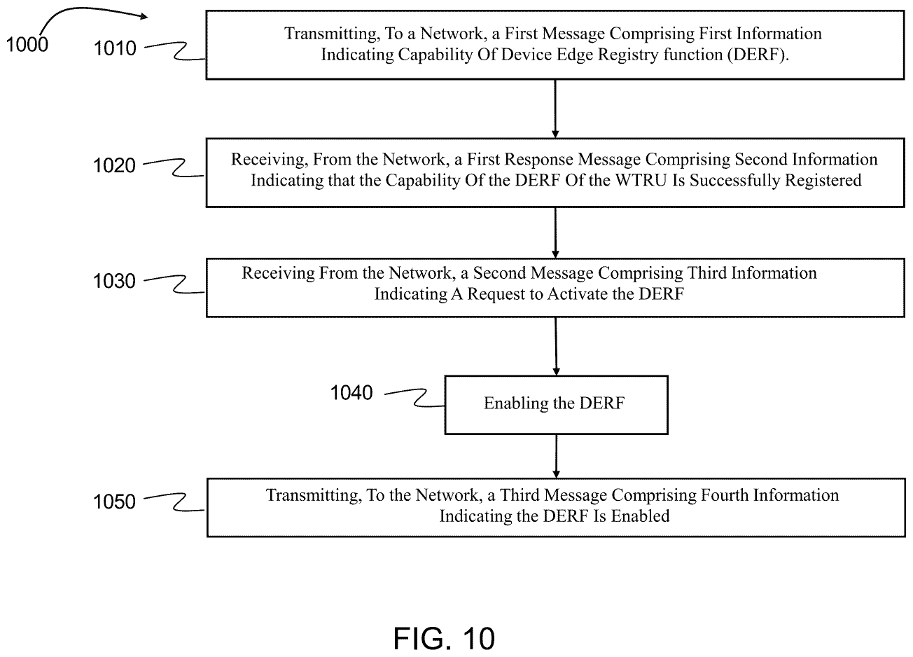

Referring to FIG. 10, in an embodiment, a method 1000, implemented in a wireless transmit/receive unit (WTRU), to register and activate a device edge registry function, may comprise a first step wherein the WTRU may transmit 1010, to a network, a first message comprising first information indicating capability of device edge registry function (DERF). The first information may further indicate any of (i) an identifier of the WTRU, (ii) credentials, (iii) capability indication flag, (iv) DERF details, location information of the WTRU, network information, and service provider information. The DERF details may include any of DERF's IP address, and DERF's Port number.

The method 1000 may further comprise a step wherein the WTRU may receive 1020, from the network, a first response message comprising second information indicating that the capability of the DERF of the WTRU is successfully processed (e.g., registered). The WTRU DERF capability processing at network side may comprise the storage of the WTRU capability information. In addition, the second information may further indicate a DERF profile.

The method 1000 may further comprise a step wherein the WTRU may receive 1030 from the network, a second message comprising third information indicating a request to activate the DERF. The third information may further indicate any of (i) the identifier of the WTRU, (ii) a DERF identifier, (iii) DERF policy details, (iv) location restriction, (v) service provider, (vi) service name, and (vii) device edge management system information (DEMS). The DEMS information may indicate any of an IP address, and Port number, which can be used to reach the DERF.

The method 1000 may further comprise a step wherein the WTRU may enable (e.g., activate) 1040 the DERF. The step of enabling (e.g., activating) the DERF by the WTRU may comprise a step wherein a DERF activation request message may be transmitted from a device edge configuration function (DECF) of the WTRU to the DERF of the WTRU, and a step wherein an activation response message comprising information indicating a DERF identifier to identify the DERF profile, and a DERF connectivity information may be received by the DECF of the WTRU.

The method 1000 may further comprise a step wherein the WTRU may transmit 1050, to the network, a third message comprising fourth information indicating the DERF is enabled (e.g., activated). The fourth information may further indicate any of (i) the WTRU identifier, (ii) the DERF identifier, (iii) DERF activation result, (iv) DERF details, (v) credentials, (vi) WTRU location information, (vii) a network identifier, and service provider information.

The WTRU may be provisioned with a device edge configuration function (DECF) by a device edge compute service provider (DECSP) or a Mobile Network Operator (MNO), with the information about a DECS of the network.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method, implemented in a wireless transmit/receive unit (WTRU), the method comprising:
transmitting, to a network, a first message comprising first information indicating capability of device edge registry function (DERF);
receiving, from the network, a first response message comprising second information indicating that the capability of the DERF of the WTRU is successfully registered;
receiving from the network, a second message comprising third information indicating a request to activate the DERF;
enabling the DERF; and
transmitting, to the network, a third message comprising fourth information indicating the DERF is enabled.

2. The method of claim 1, wherein the first information further indicates any of (i) an identifier of the WTRU, (ii) credentials, (iii) capability indication flag, (iv) DERF details, location information of the WTRU, network information, and service provider information.

3. The method of claim 2, wherein the DERF details include any of DERF's IP address, and DERF's Port number.

4. The method of claim 1, wherein WTRU DERF capability registration at network side comprises storing the WTRU capability information.

5. The method of claim 1, wherein the second information further indicates a DERF profile.

6. The method of claim 1, wherein the third information further indicates any of (i) the identifier of the WTRU, (ii) a DERF identifier, (iii) DERF policy details, (iv) location restriction, (v) service provider, (vi) service name, and (vii) device edge management system information (DEMS).

7. The method of claim 6, wherein the DEMS information indicates any of an IP address, and Port number, which can be used to reach the DERF.

8. The method of claim 1, wherein the fourth information further indicates any of (i) the WTRU identifier, (ii) the DERF identifier, (iii) DERF activation result, (iv) DERF details, (v) credentials, (vi) WTRU location information, (vii) a network identifier, and service provider information.

9. The method of claim 1, wherein enabling the DERF comprises:
transmitting, from a device edge configuration function (DECF) of the WTRU, to the DERF of the WTRU, a DERF activation request message; and
receiving, by the DECF of the WTRU, an activation response message comprising information indicating a DERF identifier to identify the DERF profile, and a DERF connectivity information.

10. The method of claim 1, wherein the WTRU is provisioned with a device edge configuration function (DECF) by a device edge compute service provider (DECSP) or a Mobile Network Operator (MNO), with the information about a DECS of the network.

11. A WTRU, comprising a processor, a transmitter, a receiver and a memory, configured to:
transmit, to a network, a first message comprising first information indicating capability of device edge registry function (DERF);
receive, from the network, a first response message comprising second information indicating that the capability of the DERF of the WTRU is successfully registered;
receive, from the network, a second message comprising third information indicating a request to activate the DERF;
enable the DERF; and
transmit, to the network, a third message comprising fourth information indicating the DERF is enabled.

12. The WTRU of claim 11, wherein the first information further indicates any of (i) an identifier of the WTRU, (ii) credentials, (iii) capability indication flag, (iv) DERF details, location information of the WTRU, network information, and service provider information.

13. The WTRU of claim 12, wherein the DERF details include any of DERF's IP address, and DERF's Port number.

14. The WTRU of claim 11, wherein WTRU DERF capability registration at network side comprises storing the WTRU capability information.

15. The WTRU of claim 11, wherein the second information further indicates a DERF profile.

16. The WTRU of claim 11, wherein the third information further indicates any of (i) the identifier of the WTRU, (ii) a DERF identifier, (iii) DERF policy details, (iv) location restriction, (v) service provider, (vi) service name, and (vii) device edge management system information (DEMS).

17. The WTRU of claim 16, wherein the DEMS information indicates any of an IP address, and Port number, which can be used to reach the DERF.

18. The WTRU of claim 11, wherein the fourth information further indicates any of (i) the WTRU identifier, (ii) the DERF identifier, (iii) DERF activation result, (iv) DERF details, (v) credentials, (vi) WTRU location information, (vii) a network identifier, and service provider information.

19. The WTRU of claim 11, wherein to enable the DERF, the WTRU is configured to:
transmit, from a device edge configuration function (DECF) of the WTRU, to the DERF of the WTRU, a DERF activation request message; and
receive, by the DECF of the WTRU, an activation response message comprising information indicating a DERF identifier to identify the DERF profile, and a DERF connectivity information.

20. The WTRU of claim 11, wherein the WTRU is provisioned with a device edge configuration function (DECF) by a device edge compute service provider (DECSP) or a mobile network operator (MNO), with the information about a DECS of the network.
